(19) United States
(12) Patent Application Publication
(10) Pub. No.: US 2025/0124697 A1
(43) Pub. Date: Apr. 17, 2025

(54) MIXTURE OF EXPERTS FOR IMAGE CLASSIFICATION

(71) Applicant: Airbnb, Inc., San Francisco, CA (US)

(72) Inventors: Xiaoxin Yin, San Jose, CA (US); Pei Xiong, San Francisco, CA (US); Jian Zhang, Burligame, CA (US)

(21) Appl. No.: 18/910,771

(22) Filed: Oct. 9, 2024

Related U.S. Application Data
(60) Provisional application No. 63/589,520, filed on Oct. 11, 2023.

(51) Int. Cl. G06V 10/80; G06V 10/774; G06V 10/82

(52) U.S. Cl. CPC G06V 10/809; G06V 10/7753; G06V 10/82

(57) ABSTRACT

Systems and methods herein describe generating a mixture of experts (MoE) models for image classification. The systems and methods include training a plurality of neural network models as experts, wherein the experts are trained to predict an image class, to predict amenities present in the image, to predict location categories in the image, or a combination thereof. The system and methods additionally include training experts based on input differentiation. The system and methods also include training experts having different model architectures or variants of model architectures, and combining the trained experts into an ensemble model. The ensemble model can then be used to classify new images.

### TECHNICAL FIELD

This application claims the benefit of priority to U.S. Provisional Application Ser. No. 63/589,520, filed Oct. 11, 2023, which is incorporated by reference herein in its entirety.

### TECHNICAL FIELD

Embodiments herein generally relate to practical applications of image classification. More specifically, the systems and methods herein describe a mixture of experts (MoE) for image classification.

### BACKGROUND

Online booking systems include data analysis and data manipulation systems that are used to review, for example, booking data to make more informed decisions before purchasing a good or service. Improved automated data analysis of certain images, such as lodging images, increases overall performance and the reach of such online booking systems.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

### BRIEF DESCRIPTION OF THE DRAWINGS

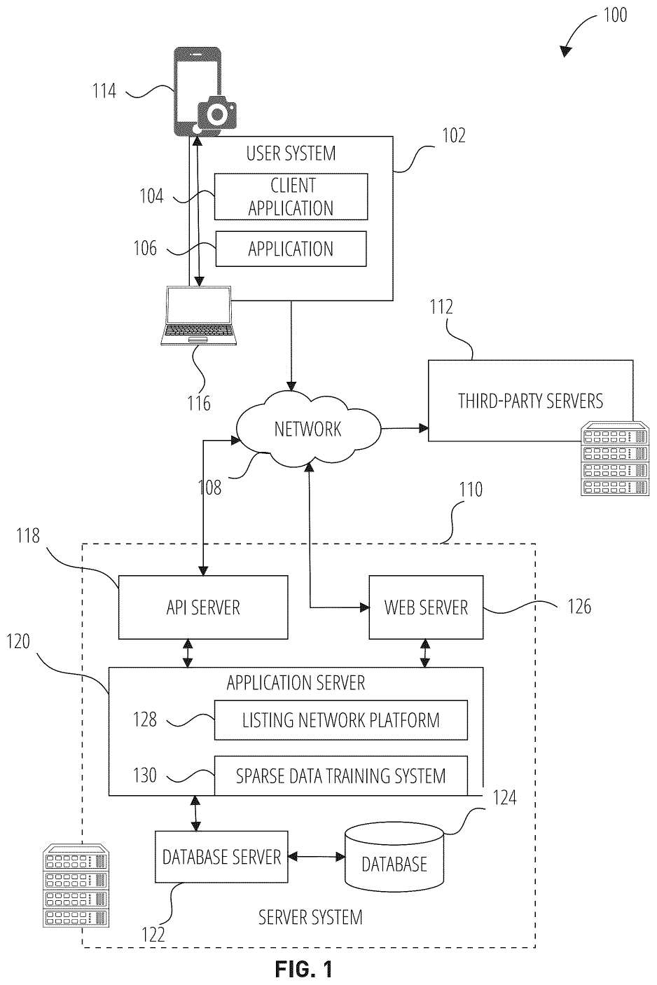

FIG. 1 is a diagrammatic representation of a networked environment in which an example of the present disclosure is be deployed, in accordance with some examples.

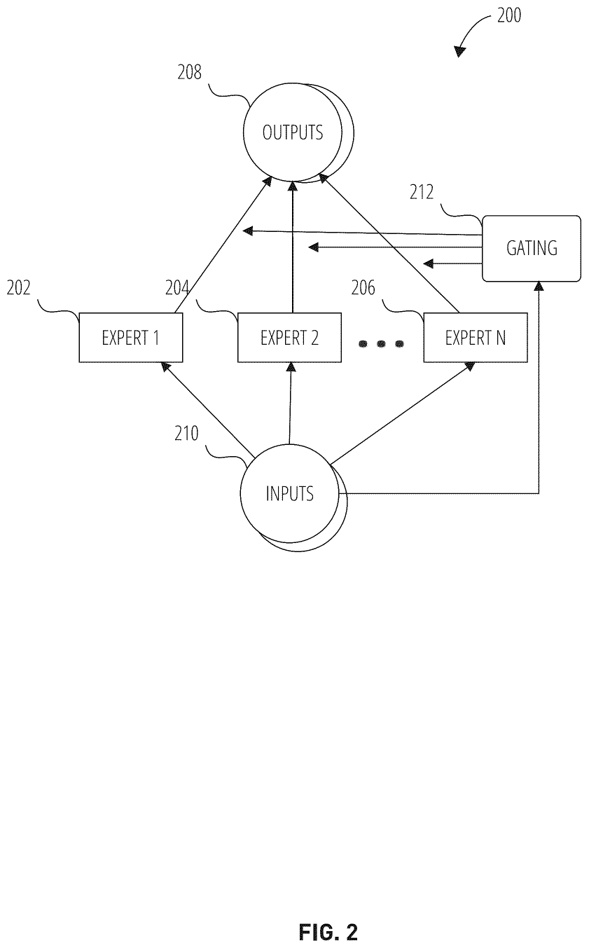

FIG. 2 is a block diagram of a Mixture of Experts (MoE) architecture, in accordance with some embodiments.

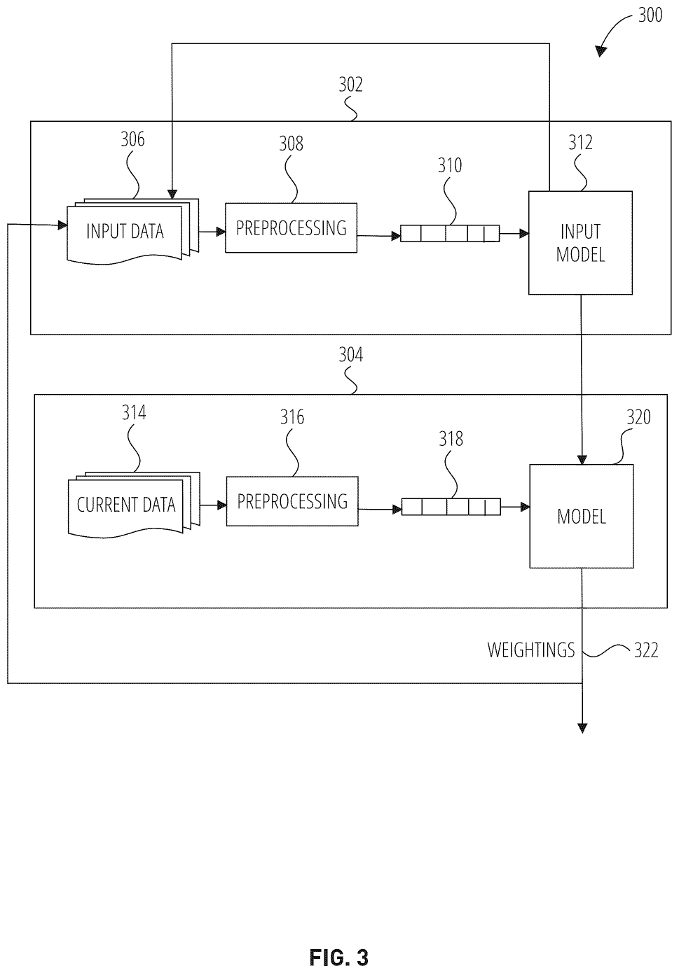

FIG. 3 illustrates a machine learning engine for image classification, in accordance with some examples.

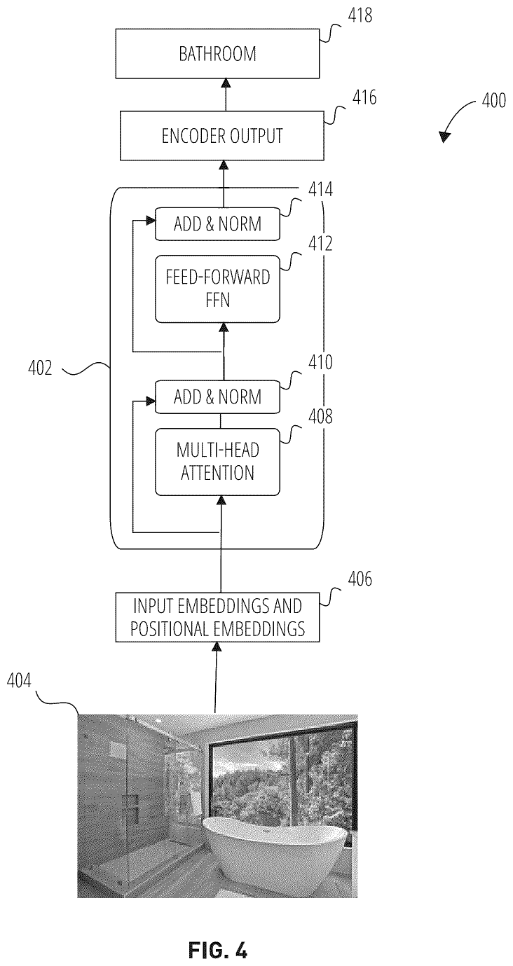

FIG. 4 is a block diagram of a multimodal expert architecture trained to classify room types, in accordance with some examples.

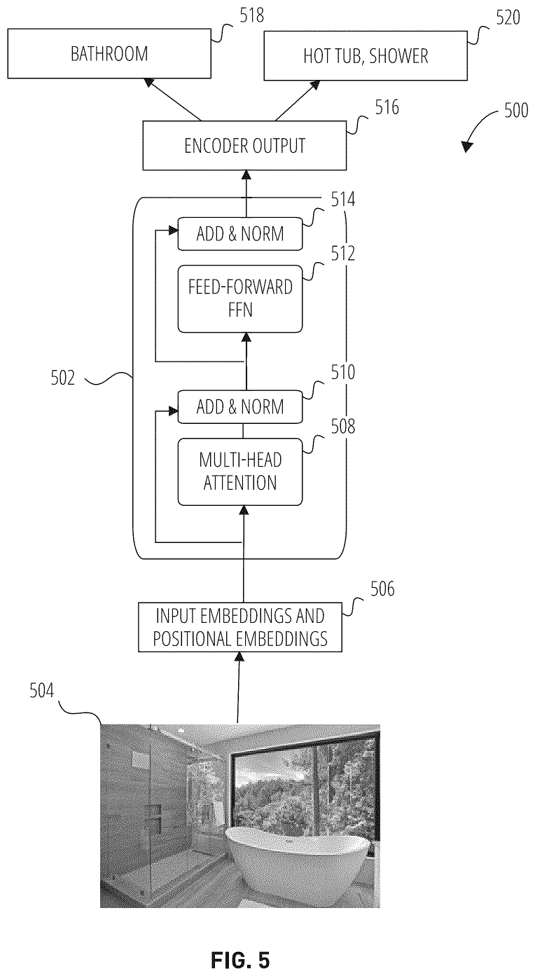

FIG. 5 is a block diagram of a multimodal expert architecture trained to classify room types and amenities, in accordance with some examples.

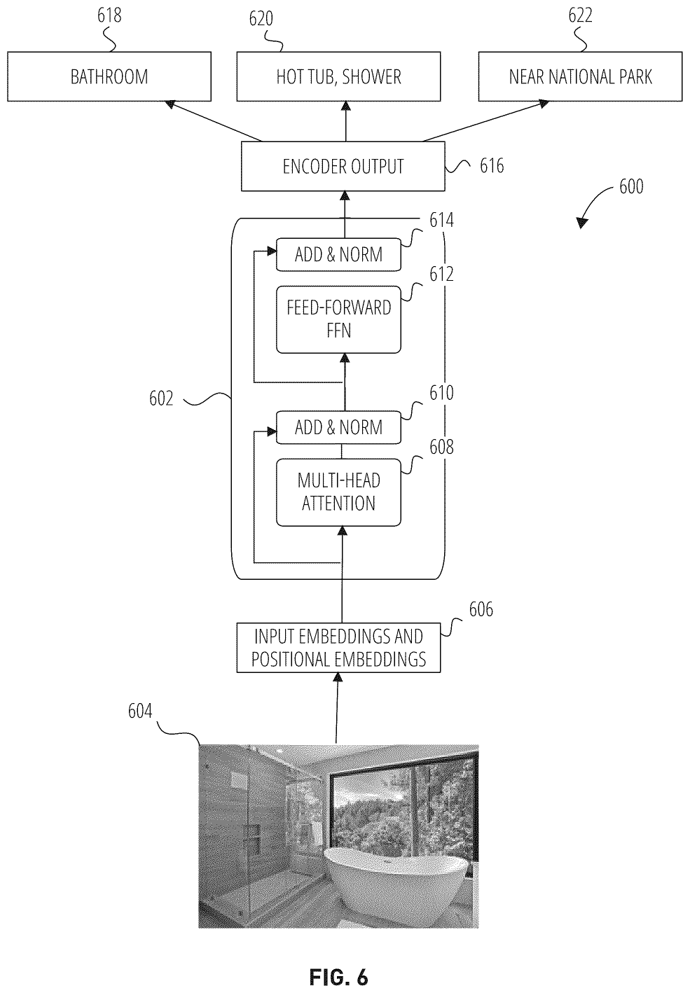

FIG. 6 is a block diagram illustrating a multimodal expert architecture trained to classify room types, amenities, and listing category locations, in accordance with some examples.

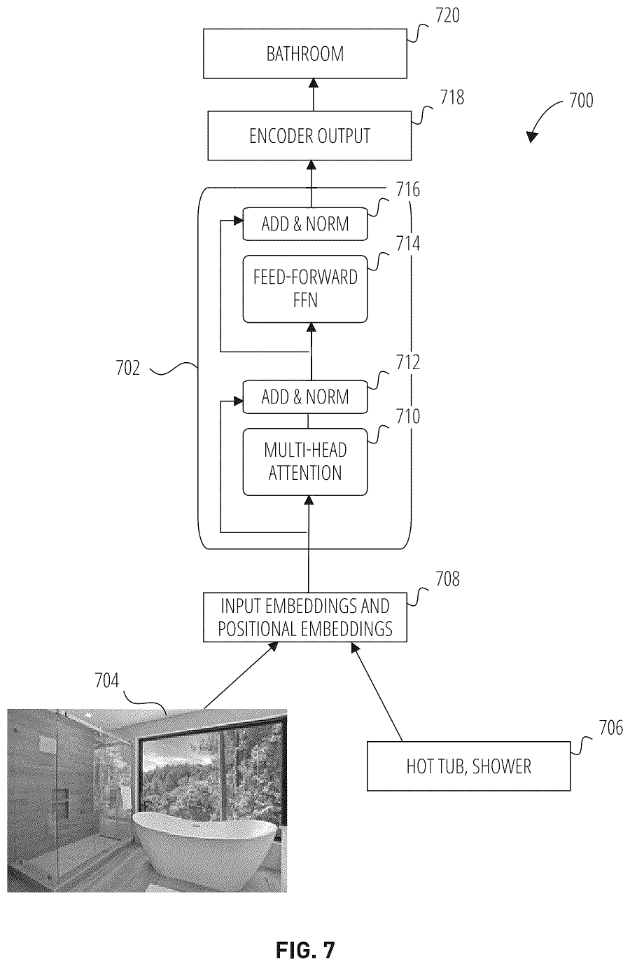

FIG. 7 is a block diagram illustrating a multimodal expert architecture trained to classify room only room types using prelabeled or predefined inputs, in accordance with some examples.

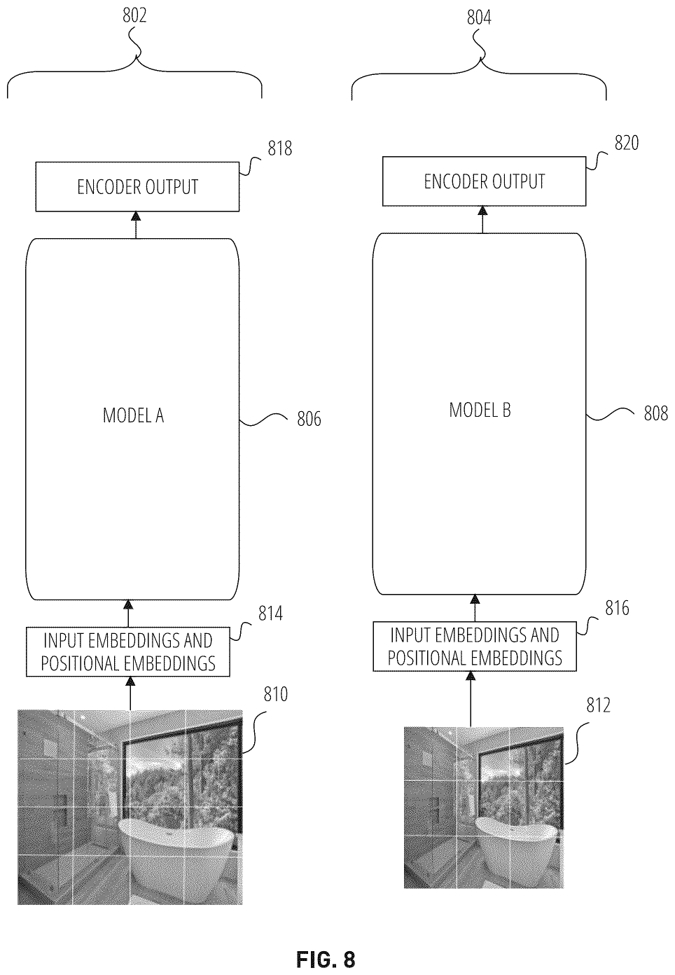

FIG. 8 is a block diagram showing side-by-side examples of two model architectures 802, 804 having different model types, in accordance with some examples.

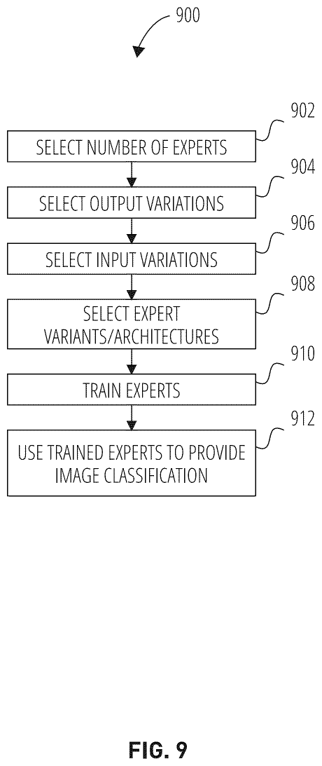

FIG. 9 illustrates an embodiment of a process suitable for applying the Mixture of Experts (MoE) techniques, in accordance with some examples.

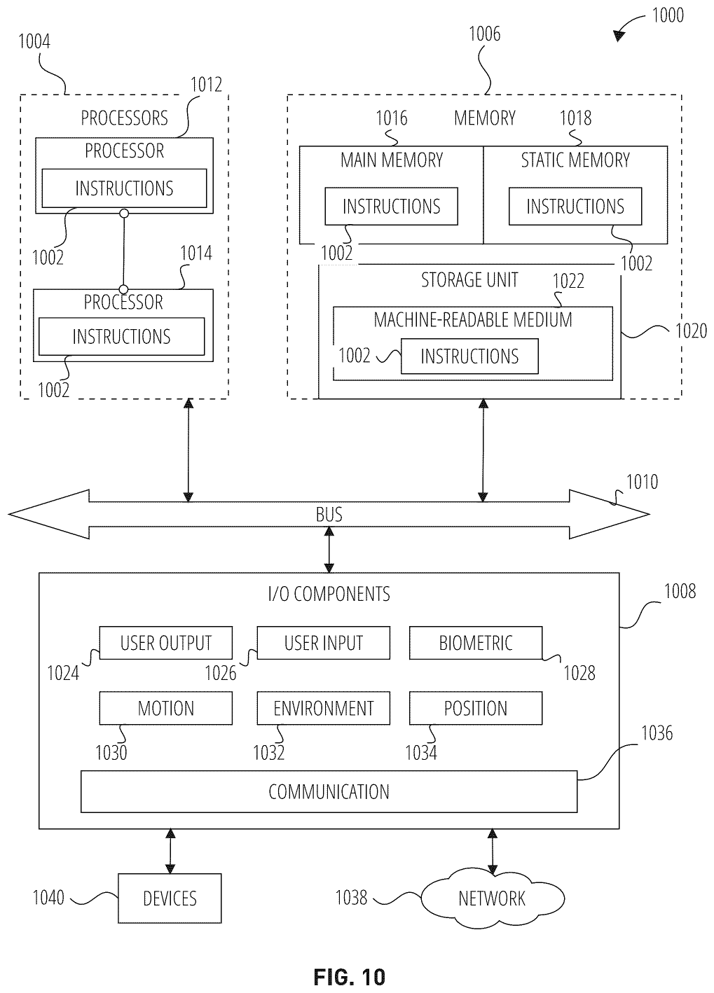

FIG. 10 is a diagrammatic representation of a machine in the form of a computer system within which a set of instructions are executed to cause the machine to perform any one or more of the methodologies discussed herein, in accordance with some examples.

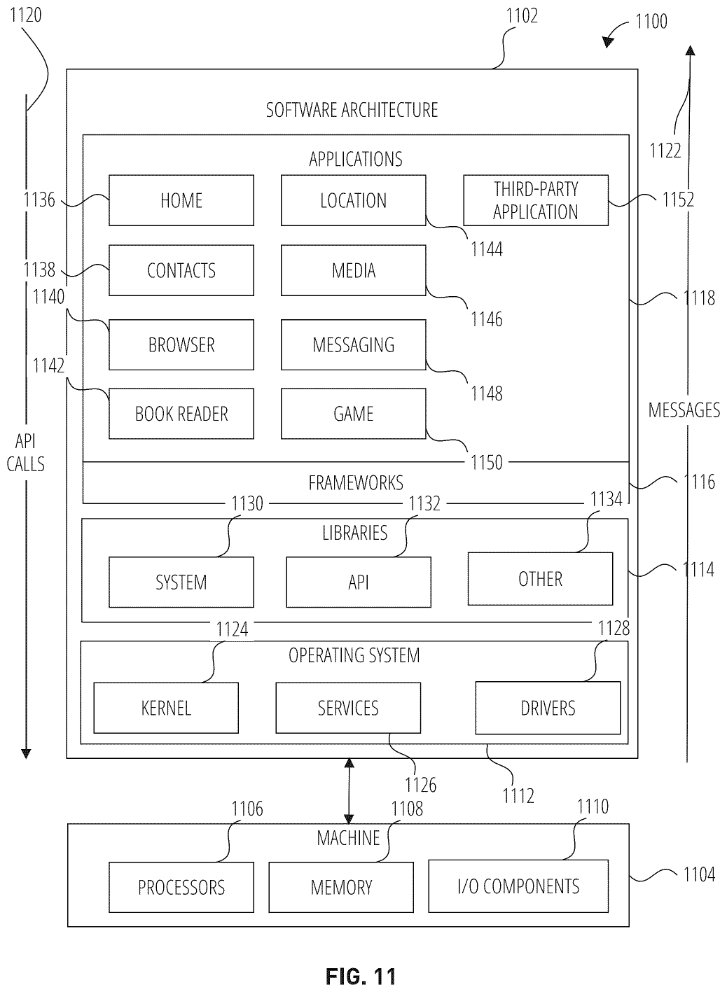

FIG. 11 is a block diagram showing an example software architecture, in accordance with some examples.

### DETAILED DESCRIPTION

The following paragraphs describe systems and methods for classifying certain images and image objects, such as lodging images to be displayed using a listing network platform. The listing network platform allows host users to list or publish, for example, accommodations or experiences, and includes one or more images as part of the listing. The techniques described herein result in practical applications, such as practical systems and methods, that automatically classify images and/or objects in the images that are found in listings of the listing network platform. For example, using the techniques described herein, an image is analyzed and labeled (e.g., kitchen with basic amenities) and a new listing can be more easily created. Likewise, the image analysis can detect certain errors, such as when a room type is incorrectly labeled (e.g., a bathroom labeled as a bedroom) and/or when certain amenities are not listed (e.g., the kitchen has a standalone freezer which is not currently included in the listing description). The techniques described herein use certain artificial intelligence models, such as neural network models further described below, that can be trained even when sparse data is present.

In some examples, the techniques described herein use a Mixture of Experts (MoE) approach for image classification. MoE as used herein combines predictions from multiple base learner models (e.g., neural network models) called “experts” to make a final prediction. In certain examples, the base learner models are trained so that they are more accurate when combined but uncorrelated when used individually. Three training approaches are described. In a first approach, the base learner models are trained to predict different auxiliary outputs, like amenities or image quality, along with room type. This training approach forces the base learner models to learn different focus areas. In a second approach, different inputs can be provided, such as the image and prelabeled amenities. That is, the models are given the pre-detected and labeled amenities as part of the input, in addition to the image data. In a third approach, different model architectures are used, including the use of models having different image resolutions or different ways of dividing the image into patches. The different model architectures described include different types of neural net model architectures, such as vision transformer (ViT) models, pure ConvNet model constructed entirely from standard ConvNet modules (ConvNeXt) models, YOLOv5, Resnet34, BASIC-L, and so on. By training expert models in different ways, the expert models will learn different aspects of the limited training data available. The ensemble of expert models working together have better performance for classifying new images compared to a single model trained on the same sparse data.

### Networked Computing Environment

FIG. 1 is a block diagram showing an example networked system 100 for facilitating listing services (e.g., publishing goods or services for sale or barter, purchases of goods or services) over a network, in accordance with some examples. The networked system 100 includes multiple user systems 102, each of which hosts multiple applications, including a client application 104 and other applications 106. Each client application 104 is communicatively coupled, via one or more communication networks including a network 108 (e.g., the Internet), to other instances of the client application 104 (e.g., hosted on respective other user systems 102), a server system 110 and third-party servers 112). A client application 104 can also communicate with locally hosted applications 106 using Applications Program Interfaces (APIs).

Each user system 102 includes multiple user devices, such as a mobile device 114 and a computer client device 116 that are communicatively connected to exchange data and messages. A client application 104 interacts with other client applications 104 and with the server system 110 via the network 108. The data exchanged between the client applications 104 and between the client applications 104 and the server system 110 includes functions (e.g., commands to invoke functions) and payload data (e.g., text, audio, video, or other multimedia data).

In some example embodiments, the client application 104 is a reservation application for temporary stays or experiences at hotels, motels, or residences managed by other end users (e.g., a posting end user who owns a home and rents out the entire home or private room). In some implementations, the client application 104 includes various components operable to present information to the user and communicate with the networked system 102. In some embodiments, if the reservation application is included in the client device 116, then the reservation application is configured to locally provide the user interface and at least some of the functionalities with the application configured to communicate with the networked system 102, on an as-needed basis, for data or processing capabilities not locally available (e.g., access to a database of items available for sale, to authenticate a user, to verify a method of payment). Conversely, if the reservation application is not included in the client device 116, the client device 116 can use its web browser to access the e-commerce site (or a variant thereof) hosted on the networked system 102.

The server system 110 provides server-side functionality via the network 108 to the client applications 104. While certain functions of the networked system 100 are described herein as being performed by either a client application 104 or by the server system 110, the location of certain functionality either within the client application 104 or the server system 110 can be a design choice. For example, it can be technically preferable to initially deploy particular technology and functionality within the server system 110 but to later migrate this technology and functionality to the client application 104 where a user system 102 has sufficient processing capacity.

The server system 110 supports various services and operations that are provided to the client application 104. Such operations include transmitting data to, receiving data from, and processing data generated by the client applications 104. This data can include message content, client device information, geolocation information, reservation information, transaction information, message content. Data exchanges within the networked system 100 are invoked and controlled through functions available via user interfaces (UIs) of the client application 104.

Turning now specifically to the server system 110, an Application Program Interface (API) server 118 is coupled to and provides programmatic interfaces to application server 120, making the functions of the application server 120 accessible to the client application 104, other applications 106 and third-party server 112. The application server 120 is communicatively coupled to a database server 122, facilitating access to a database 124 that stores data associated with interactions processed by the application server 120. Similarly, a web server 126 is coupled to the application server 120 and provides web-based interfaces to the application server 120. To this end, the web server 126 processes incoming network requests over the Hypertext Transfer Protocol (HTTP) and several other related protocols.

The Application Program Interface (API) server 118 receives and transmits interaction data (e.g., commands and message payloads) between the application server 120 and the user systems 102 (and, for example, interaction clients 104 and other application 106) and the third-party server 112. Specifically, the Application Program Interface (API) server 118 provides a set of interfaces (e.g., routines and protocols) that can be called or queried by the client application 104 and other applications 106 to invoke functionality of the application server 120. The Application Program Interface (API) server 118 exposes various functions supported by the application server 120, including account registration and login functionality.

The application server 120 hosts the listing network platform 128 and a sparse data training system 130 each of which comprises one or more modules or applications and each of which can be embodied as hardware, software, firmware, or any combination thereof. The application server 120 is shown to be coupled to a database server 122 that facilitates access to one or more information storage repositories or database(s) 124.

The listing network platform 128 provides a number of publication functions and listing services to the users who access the networked system 100. While the listing network platform 128 is shown in FIG. 1 to form part of the networked system 100, it will be appreciated that, in alternative embodiments, the listing network platform 128 forms part of a web service that is separate and distinct from the networked system 100. The listing network platform 128 can be hosted on dedicated or shared server machines that are communicatively coupled to enable communications between server machines. The listing network platform 128 provides a number of publishing and listing mechanisms whereby a seller (also referred to as a “first user,” posting user, host) lists (or publishes information concerning) goods or services for sale or barter, a buyer (also referred to as a “second user,” searching user, guest) can express interest in or indicate a desire to purchase or barter such goods or services, and a transaction (such as a trade) is completed pertaining to the goods or services.

The sparse data training system 130 uses neural network training techniques, such as, multimodal (e.g., multi-model) training. Three training approaches are used by the sparse data training system 130. In a first approach, the models, including models having multiple network architectures, are trained to predict different auxiliary outputs, like amenities or image quality, along with room type. In a second approach, different inputs can be provided, such as the image and pre-detected amenities. That is, the models are given the pre-detected amenities as part of the input. In a third approach, different model architectures are used and combined, including the use of different image resolutions or different ways of dividing the image into patches and/or different model architectures, such ViT, ConvNeXt, YOLOv5, Resnet34, BASIC-L, and the like, as further described below. By using a combination of multiple experts together, the combination shows improved performance in classifying new images compared to a single model trained on the same sparse data. Further details of training are described below.

FIG. 2 is a block diagram of a Mixture of Experts (MoE) architecture 200, in accordance with some examples. In the depicted example, multiple experts 202, 204, 206 are shown. Each expert 202, 204, 206 is a neural network model. In some examples, all experts 202, 204, 206 are the same type of neural network model, e.g., ViT, ConvNeXt, YOLOv5, Resnet34, BASIC-L, or any other type. In other examples, some of the experts are of the same type of neural network models while other of the experts are of a different type. In yet another embodiment, all experts are different types of neural network models.

Each of the experts 202, 204, 206 are trained on subtasks of a predictive modeling problem of image classification. The subtasks include 1) training an expert to identify different output types 208 (e.g., room type only, room type and also room amenities), 2) training using different input types 210 (e.g., raw image, raw image with amenities pre-derived or pre-labeled), and 3) training using multiple model types (e.g., different model architectures and/or the use of different image resolutions or different ways of dividing the image into patches). A gating model 212 is then used to decide which expert(s) to use. In some examples, the experts' predictions are “pooled” with the gating model 212 output to make a final prediction. An ensemble model that combines several models, such as the expert models 202, 204, 206, with the gating model, is thus provided.

In certain examples, the mixture of expert models 202, 204, 206 each make a prediction, such as identifying a room, and a final prediction is achieved using a pooling or aggregation technique by combining the output contributions, such as the prediction of each expert model 202, 204, 206, the weight given the prediction, and so on, via the gating model 212 into a final determination. In one pooling example, the expert having the largest output or confidence is selected. Alternatively, a weighted sum prediction is made that explicitly combines the predictions made by each expert and the confidence estimated by the gating model 212. For example, the gating model 212 provides a set of weights or confidences for how much, such as a percentage amount, that each expert should contribute to the final prediction. In some examples, the gating model 212 derives the set of weights or confidences by testing each model 202, 204, 206 using an input test data set. The gating model 212 uses the input test data set as input to each of the models 202, 204, 206 and the output of the models 202, 204, 206 is then evaluated to give a weight or a confidence value to each model 202, 204, 206. In some examples, models that classify the input test data more accurately are given higher weights and/or higher confidence values. In some examples, the weights and/or confidence values are combined by the gating model 212 via weighed average, where each model's output is multiplied by a pre-defined weight (representing the model's importance or accuracy confidence), and the weighted outputs are summed to produce the final output. In certain examples, the weights and/or confidence values are also combined by the gating model 212 via weighed voting, where each model's vote is multiplied by its weight, and the final decision is made based on the weighted sum of votes.

By using the MoE architecture 200, an improved accuracy of image classification is provided, especially in circumstances with sparse data (e.g., less than 150,000 images, less than 100,000 images). More generally, data is sparse when overfitting occurs. Overfitting occurs when the model cannot generalize and fits too closely to the training data set. Accordingly, sparse data sets not only include data sets with low numbers of images but additionally or alternatively data sets that result in overfitting. The MoE techniques described herein, including certain machine learning engines and/or AI model architectures, address these technical problems to provide for improved image classification and detection of objects with sparse data sets.

FIG. 3 illustrates a machine learning engine 300 for image classification, in accordance with some examples. The machine learning engine 300 can be deployed to execute at a server (e.g., distributed online server) or a computer. The machine learning engine 300 uses a training engine 302 and a prediction engine 304. Training engine 302 uses input data 306, for example after the input data 306 undergoes a preprocessing via a preprocessing component 308, to derive one or more features 310. The one or more features 310 can be used to generate an initial input model 312, which is updated iteratively or retrained with future data (e.g., data that will be generated during use of the input model 312) that includes labeled or unlabeled data (e.g., during reinforcement learning). The input data 404 can include various types of images, such as images of rooms, images of the outside of a residence, images depicting exterior and/or interior views of a hotel, images of amenities included in various rooms (e.g., television, refrigerators, hot tubs, expresso maker, kitchen utensils, ovens, spas, and so on). In some examples, the input data can be split into images of rooms, into images of rooms including amenities, and/or into images having amenities only.

In the prediction engine 304, current data 314 (e.g., image data for a listing in the listing network platform 128) can be input to preprocessing component 316. In some examples, preprocessing component 316 and preprocessing component 308 are the same. The prediction engine 304 produces feature vector 318 from the preprocessed current data, which is input into the model 320 to generate one or more criteria weightings 322. The criteria weightings 322 can be used to output a prediction, as discussed further below. The training engine 302 operates, in some examples, in an offline manner to train the model 320 (e.g., on a server). Additionally, the prediction engine 304 operates in an online manner (e.g., in real-time, at a mobile device, on a wearable device, etc.), in some examples. The model 320 is periodically updated via additional training (e.g., via updated input data 306 or based on labeled or unlabeled data output in the weightings 322) and/or based on identified future data, such as by using reinforcement learning to personalize a general model (e.g., the initial model 312) to a particular user. Labels for the input data 306 includes room type (e.g., “bathroom”, “bedroom”, “kitchen”, “living room”, “loft”, “spa”, and so on) amenity type (e.g., “hot tub”, “double oven”, “full size refrigerator”, “expresso maker”, and so on), locations (e.g., “near a national park”, “beachfront”, “downtown”, “on the metro train route” and so on), and/or residence type (e.g., “single room”, whole house”, “hotel room”, “apartment”, “efficiency”, and so on).

The initial model 312 is updated using further input data 306 until a model 320 that provides satisfactory image analysis is generated. The model 320 generation is stopped according to a specified criteria (e.g., after sufficient input data is used, such as 1,000, 10,000, 300,000 data points, etc.) or when data converges (e.g., similar inputs produce similar outputs). The specific machine learning algorithm used for the training engine 302 is selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models do not have a training engine 302. In an example embodiment, a regression model is used and the model 320 is a vector of coefficients corresponding to a learned importance for each of the features in the vector of features 310, 318. A reinforcement learning model uses techniques such as Q-Learning, a deep Q network, a Monte Carlo technique including policy evaluation and policy improvement, a State-Action-Reward-State-Action (SARSA), a Deep Deterministic Policy Gradient (DDPG), or the like. Once trained, the model 320 outputs an image classification, such as room type, room type, amenity types found in the room, surroundings and/or residence type. As mentioned earlier, the models 320 include ViT, ConvNeXt, and/or other model types, such as YOLOv5, Resnet34, BASIC-L, and so on. The models 312, 320 include a variety of model architectures, as further described below.

FIG. 4 is a block diagram of a multimodal expert architecture 400 trained to classify room types, in accordance with some examples. In the depicted example, a transformer neural network model 402, such as ViT, is shown. An image 404, such as an image for analysis (e.g., classification), is used as input. More specifically, the image 404 is used via input embeddings and positional embeddings 406. Input embeddings include embedding layer(s) that can be thought of as lookup table(s) to retrieve a learned vector representation of image parts or patches. Neural networks such as networks using the architecture 400 learn through numbers so each image maps to a vector with continuous values to represent an image part (e.g, pixel area). Positional information is then injected into the embeddings, for example, via positional encodings.

A multi-head attention block 408 includes multiple “heads” that allow the transformer neural network model 402 to focus on different parts or portions of the input simultaneously. Each head learns to pay attention to different types of relationships in input data, enabling the capture of various types of relationships. As mentioned before, the input image is first converted into input embeddings and positional embeddings to be used by the multiple heads. After obtaining the output from each head, a concatenation of all the heads' outputs is then performed. An add and normalize block or layer 410 is then used for residual connection (add) and layer normalization (norm). Residual connections help to mitigate a vanishing gradient problem, which can be prevalent in deep networks. By adding the input directly to the output, the gradient has a shortcut path during backpropagation, making it easier to train very deep networks. Residual connections can be thought of as allowing the model to learn modifications to the identity function rather than learning the entire transformation. This can make learning more efficient, as the model can focus on the changes or “residuals” needed.

The application of layer normalization, such as via the layer 410, standardizes the activations of a layer, which helps in stabilizing the training process. This is more useful in a model such as the transformer neural network model 402 where “stacks” include multiple multi-head attention 408 and feed forward 412 layers. Without normalization, activations can reach large or small values, which can lead to numerical instability or slowing down the optimization. Layer normalization computes statistics over the feature dimension and is invariant to batch size.

The feed-forward block or layer 412, position-wise, is a fully connected feed-forward network (FFN) that is applied independently to each position. That is, the feed-forward network does not consider relationships between different positions in the sequence. Instead, the feed-forward layer 412 applies the same linear transformations to each position separately. The feed-forward layer 412 includes two linear transformations (e.g., two dense layers). Between these linear transformations, a non-linear activation function is applied. In some examples, a ReLU (Rectified Linear Unit) activation function is used. While the multi-head attention layer 408 allows the model to focus on different parts of the input and capture dependencies regardless of their distance in the sequence, the feed-forward layer 412 provides the model with the capacity to represent more complex functions and transformations on the data. Weights in the feed-forward layer 412 are not shared across positions or layers.

Another add and normalize block or layer 414 then follows the feed-forward layer 412, similar in structure and functionality to the add and normalize layer 410. An encoder output 416 then is used to determine, for example, a room type 418. In some examples, all layers 408-414 in the transformer neural network model 402 are referred to as an encoder stack. Accordingly, the output 416 of the transformer neural network model 402 is the final representations produced by the last layer, e.g., layer 414 in the depicted example. In the depicted example of FIG. 4, multimodal learning is used in a first mode or model, where a learner (e.g, model 402) learns to identify room types only. FIG. 5 shows an example where a learner is trained to identify a type of room as well as amenities found in the room.

Turning now to FIG. 5, the figure is a block diagram of a multimodal expert architecture 500 trained to classify both room types and amenities, in accordance with some examples. In the depicted example, a transformer neural network model 502, such as ViT, is shown, receiving an input image 504 via input embeddings and positional embeddings 506. The transformer neural network model 502 includes the same of similar blocks or layers, such as a multi-head attention block or layer 508, an add and normalize block or layer 510, a feed-forward block or layer 512, and a second add and normalize block or layer 514, equivalent to the respective multi-head attention block or layer 408, the add and normalize block or layer 410, the feed-forward block or layer 412, and the second add and normalize block or layer 414 previously described in FIG. 4. However, under multimodal training, the multimodal expert architecture 500 has been trained not only to classify room types but also amenities found in the rooms. Accordingly, the input image 504 will be used, via the input embeddings and positional embeddings 506, to derive encoder output 516 that includes derivations for room types 518 and for amenities 520. Indeed, by adding multimodal experts to a predictive analysis, the combination of outputs, e.g., outputs 416, 516, each expert is providing more focused analysis that notice certain parts or patterns in an image, increasing accuracy even in the presence of sparse data. Output differentiating is not limited to room types and room amenities, but other factors can be used. For example, FIG. 6 shows a multimodal expert architecture trained to classify room types, room amenities, and location categories.

More specifically, FIG. 6 is a block diagram illustrating a multimodal expert architecture 600 trained to classify room types, amenities, and location categories, in accordance with some examples. In the depicted example, a transformer neural network model 602, such as ViT, is shown, receiving an input image 604 via input embeddings and positional embeddings 606. The transformer neural network model 602 includes the same of similar blocks or layers, such as a multi-head attention block or layer 608, an add and normalize block or layer 610, a feed-forward block or layer 612, and a second add and normalize block or layer 614, equivalent to the respective multi-head attention block or layer 408, the add and normalize block or layer 410, the feed-forward block or layer 412, and the second add and normalize block or layer 414 previously described in FIG. 4. Similar or equivalent layers are also shown in FIG. 5. However, under multimodal training, the multimodal expert architecture 600 has been trained not only to classify room types and amenities found in the rooms, but additionally, location categories (e.g., beachside, forest, mountaintop, near a train station, and so on). Accordingly, the input image 604 will be used, via the input embeddings and positional embeddings 606, to derive encoder output 616 that includes derivations for room types 618, for amenities 620, and for location classification 622. Adding multimodal experts each trained in various output categories improves final image classification via diverse and focused analysis that notice certain parts or patterns in an image, increasing accuracy. The experts (e.g., models 402, 502, 602) are not limited to output training differentiation, input training differentiation is also used.

FIG. 7 is a block diagram illustrating a multimodal expert architecture 700 trained to classify room only room types using input training differentiating via prelabeled or predefined inputs, in accordance with some examples. In the depicted example, a transformer neural network model 702, such as ViT, is shown, receiving an input image 704 and a prelabeled input 706 via input embeddings and positional embeddings 708. The transformer neural network model 702 includes the same of similar blocks or layers, such as a multi-head attention block or layer 710, an add and normalize block or layer 712, a feed-forward block or layer 714, and a second add and normalize block or layer 716, equivalent to the respective multi-head attention block or layer 408, the add and normalize block or layer 410, the feed-forward block or layer 412, and the second add and normalize block or layer 414 previously described in FIG. 4. Similar or equivalent layers are also shown in FIGS. 5 and 6. However, under multimodal training, the multimodal expert architecture 700 has been trained not only on images but also on prelabeled amenities, such as the example amenities 706, as input.

Accordingly, the input image 704 will be used in addition to one or more prelabeled amenities 706 via the input embeddings and positional embeddings 708, to derive encoder output 718 that includes derivations for room types 720. Adding multimodal experts each trained in various focuses output and input categories thus improves final image classification by focusing each expert in desired areas (e.g., output areas, input areas). The experts (e.g., models 402, 502, 602, 702) can then be combined, e.g., via the gating model 212 shown in FIG. 2, to derive a combined image classification. Different model types can also be used, as further described below.

FIG. 8 is a block diagram showing side-by-side examples of two model architectures 802, 804 having different model types, in accordance with some examples. In the depicted example, a model A 806 is a ViT model while a model B 808 is a ConvNeXt model. However, models using the MoE approach can include models of various architectures, types, or variants, such as ViT, ConvNeXt, YOLOv5, Resnet34, BASIC-L, and so on, in combination. In the depicted example, variants of a model of the same type, such as ViT, can be created using different input image resolutions and “patch” sizes. For example, input image 810 includes 16 patches or grid divisions at a higher resolution than image 812, which includes 9 patches or grid divisions. That is, some expert models are trained with images divided into X grid divisions and other expert models are trained with images divided into Y grid divisions where X is not equal to Y. By training each expert model using different grid divisions, the resulting trained models can provide improved accuracy during the image analysis when used in combination with each other. It is to be noted that the combination can include 2, 3, 4 or more models each trained with a different grid division of the same (or similar) images.

In the depicted embodiment, the input images 810, 812 are provided, via respective input embeddings and positional embeddings 814, 816. The models 806 and 808 then process the input data based on their respective architectures and produce encoder outputs 818, 820. The encoder outputs 818, 820 provide image classification as desired, such as by room type, by room amenities, and/or by location classification. Accordingly, experts, such as base learners, can be trained by using different output types, different input types, and can additionally include different variants and/or architecture types. The experts then apply more focused learning to sparse data training sets, and when combined, improve image classification when compared to other techniques, such as boosting techniques, that train a series of weak learners (models that do only slightly better than random guessing) in a sequential manner, where each subsequent model attempts to correct the mistakes made by the previous ones.

FIG. 9 illustrates an embodiment of a process 900 suitable for applying the Mixture of Experts (MoE) techniques described herein, in accordance with some examples. In the depicted example, the process selects, at block 902, a desired number of experts to use. For example, larger training data sets would likely use a smaller number of experts since training data overfitting can then be less of an issue when compared to sparser training data sets. The process 900 then selects, at block 904, output variations to use to train the selected experts. For example, some of the experts are trained on room identification only, while other experts are trained on both room and on amenity identification. In other examples, some of the experts are trained on both room and on amenity identification as well as on location identification. Some example output variations for training purposes include room type, amenity type, location categories, and/or room size.

The process 900 selects, at block 906, input variations to train the selected experts. For example, some experts are trained with image data only, while other experts are trained with both image data and prelabeled amenities found in the image data. Some example input variations for training purposes include image data, prelabeled amenities, and/or prelabeled location categories. The process 900 then selects, at block 908, some (or all) of the experts to have different variants and/or model architectures. For example, some of the experts are assigned ViT, ConvNeXt, YOLOv5, Resnet34, and/or BASIC-L architectures as well as variants among these architectures. It is to be noted that any image classification model architecture can be used, and the listed architectures are for example purposes only.

The process 900 the trains, at block 910, the various experts based on their configuration. That is, experts that use only image data are given only image data as input, experts that use image data and prelabeled amenities are given both image data and labeled amenities, and so on. The experts can be trained in parallel for improved efficiency purposes. Once the experts are trained, the process 900 uses the trained experts, at block 912, to classify image data. In one example, the expert having the largest output or confidence is selected to provide the output results. Alternatively, a weighted sum prediction is made that explicitly combines the predictions made by each expert and the confidence estimated by the gating model 212 described in FIG. 2. For example, the gating model 212 derives a set of weights or confidences for how much each expert should contribute to the final prediction and the set of weights is then used to combine the outputs of all the experts. By providing for MoE techniques as described, a more accurate image classification can be obtained even when using sparse training data.

For example, during a user of the listing network platform 128 uploads various pictures and/or video during the creation or updating of a listing. The user then activates a “analyze image” control, such as a menu item, a button, a key press, and so on, and the listing network platform 128 will then analyze the image via the gating model 212 and/or the expert models 202, 204, 206. The analysis, for example, includes a list of room types detected, and for each room, a list of amenities (e.g., kitchen basics, bread maker, spa tub, treadmill, and so on). The analysis also includes a list of locations that have been found in the images (e.g., beach, near downtown, on the commuter train route, and so on). The analysis is then used, for example, for error correction and/or for creating/updating the user's listing. In some examples, the analysis is performed after the user has created the listing, and the listing network platform 128 can then provide the user with discrepancies between the listing and the output of the analysis and/or omissions in the listing. Additionally or alternatively, the image analysis can be used before the listing is created to automatically identify rooms, amenities, and/or locations to include as the listing is created. The image analysis also identifies image areas and their corresponding description (e.g., room name, amenity, location).

### Machine Architecture

FIG. 10 is a diagrammatic representation of the machine 1000 within which instructions 1002 (e.g., software, a program, an application, an applet, an app, or other executable code) for causing the machine 1000 to perform any one or more of the methodologies discussed herein can be executed, in accordance with some examples. For example, the instructions 1002 cause the machine 1000 to execute any one or more of the methods described herein. The instructions 1002 transform the general, non-programmed machine 1000 into a particular machine 1000 programmed to carry out the described and illustrated functions in the manner described. The machine 1000 operates as a standalone device and/or coupled (e.g., networked) to other machines. In a networked deployment, the machine 1000 operates in the capacity of a server machine or a client machine in a server-client network environment, or as a peer machine in a peer-to-peer (or distributed) network environment. The machine 1000 comprises, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. The machine 1000, for example, can comprise the user system 102 or any one of multiple server devices forming part of the server system 110. In some examples, the machine 1000 also comprise both client and server systems, with certain operations of a particular method or algorithm being performed on the server-side and with certain operations of the particular method or algorithm being performed on the client-side.

The machine 1000 include processors 1004, memory 1006, and input/output I/O components 1008, which are configured to communicate with each other via a bus 1010. In an example, the processors 1004 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, a processor 1012 and a processor 1014 that execute the instructions 1002. The term “processor” is intended to include multi-core processors that comprise two or more independent processors (sometimes referred to as “cores”) that execute instructions contemporaneously. Although FIG. 10 shows multiple processors 1004, the machine 1000 can include a single processor with a single-core, a single processor with multiple cores (e.g., a multi-core processor), multiple processors with a single core, multiple processors with multiples cores, or any combination thereof.

The memory 1006 includes a main memory 1016, a static memory 1018, and a storage unit 1020, both accessible to the processors 1004 via the bus 1010. The main memory 1006, the static memory 1018, and storage unit 1020 store the instructions 1002 embodying any one or more of the methodologies or functions described herein. The instructions 1002 also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 include a wide variety of components to receive input, provide output, produce output, transmit information, exchange information, capture measurements, and so on. The specific I/O components 1008 that are included in a particular machine will depend on the type of machine. For example, portable machines such as mobile phones include a touch input device or other such input mechanisms, while a headless server machine will likely not include such a touch input device. It will be appreciated that the I/O components 1008 include many other components that are not shown in FIG. 10. In various examples, the I/O components 1008 include user output components 1024 and user input components 1026. The user output components 1024 include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1008 include biometric components 1028, motion components 1030, environmental components 1032, or position components 1034, among a wide array of other components. For example, the biometric components 1028 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components include a brain-machine interface (BMI) system that allows communication between the brain and an external device or machine. This is achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data is used for very limited purposes, such as identification verification. To ensure limited and authorized use of biometric information and other personally identifiable information (PII), access to this data is restricted to authorized personnel only, if at all. Any use of biometric data is strictly be limited to identification verification purposes, and the data is not shared or sold to any third party without the explicit consent of the user. In addition, appropriate technical and organizational measures are implemented to ensure the security and confidentiality of this sensitive information.

The motion components 1030 include acceleration sensor components (e.g., accelerometer), gravitation sensor components, rotation sensor components (e.g., gyroscope).

The environmental components 1032 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that provide indications, measurements, or signals corresponding to a surrounding physical environment.

With respect to cameras, the user system 102 includes a camera system comprising, for example, front cameras on a front surface of the user system 102 and rear cameras on a rear surface of the user system 102. The front cameras, for example, are used to capture still images and video of a user of the user system 102 (e.g., “selfies”), which can then be augmented with augmentation data (e.g., filters) described above. The rear cameras, for example, are used to capture still images and videos in a more traditional camera mode, with these images similarly being augmented with augmentation data. In addition to front and rear cameras, the user system 102 also includes a 360° camera for capturing 360° photographs and videos.

Further, the camera system of the user system 102 includes dual rear cameras (e.g., a primary camera as well as a depth-sensing camera), or even triple, quad or penta rear camera configurations on the front and rear sides of the user system 102. These multiple cameras systems include a wide camera, an ultra-wide camera, a telephoto camera, a macro camera, and a depth sensor, for example.

The position components 1034 include location sensor components (e.g., a GPS receiver component), altitude sensor components (e.g., altimeters or barometers that detect air pressure from which altitude is derived), orientation sensor components (e.g., magnetometers), and the like.

Communication is implemented using a wide variety of technologies. The I/O components 1008 further include communication components 1036 operable to couple the machine 1000 to a network 1038 or devices 1040 via respective coupling or connections. For example, the communication components 1036 include a network interface component or another suitable device to interface with the network 1038. In further examples, the communication components 1036 include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1040 include another machine or any of a wide variety of peripheral devices (e.g., a peripheral device coupled via a USB).

Moreover, the communication components 1036 detect identifiers or include components operable to detect identifiers. For example, the communication components 1036 include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information is derived via the communication components 1036, such as location via Internet Protocol (IP) geolocation, location via Wi-Fi® signal triangulation, location via detecting an NFC beacon signal that indicates a particular location, and so forth.

The various memories (e.g., main memory 1016, static memory 1018, and memory of the processors 1004) and storage unit 1020 store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 are transmitted or received over the network 1038, using a transmission medium, via a network interface device (e.g., a network interface component included in the communication components 1036) and using any one of several well-known transfer protocols (e.g., hypertext transfer protocol (HTTP)). Similarly, the instructions 1002 are transmitted or received using a transmission medium via a coupling (e.g., a peer-to-peer coupling) to the devices 1040.

### Software Architecture

FIG. 11 is a block diagram 1100 illustrating a software architecture 1102, which can be installed on any one or more of the devices described herein. The software architecture 1102 is supported by hardware such as a machine 1104 that includes processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematic functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which is specific to a particular operating system or platform.

In an example, the applications 1118 include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ software development kit (SDK) by an entity other than the vendor of the particular platform) include mobile software running on a mobile operating system such as IOS™, ANDROID™, WINDOWS® Phone, or another mobile operating system. In this example, the third-party application 1152 can invoke the API calls 1120 provided by the operating system 1112 to facilitate functionalities described herein.

What is claimed is:

1. A system, comprising:
a memory storing instructions; and
one or more hardware processors configured to execute the instructions to perform operations comprising:
selecting a plurality of Artificial Intelligence (AI) models for training in image classification;
training a first AI model of the plurality of AI models to only derive a room type from a room depicted in an image, to derive both the room type and an amenity found in the room, to derive a location from the image, or a combination thereof, based on a first training data set;
training a second AI model of the plurality of AI models to only derive the room type from the room depicted in the image, to derive both the room type and the amenity found in the room, to derive the location from the image, or a combination thereof, based on a second data set having a different type from the first data set;
combining the first AI model and the second AI model into an ensemble model; and
providing the ensemble model to classify images.

2. The system of claim 1, the operations further comprising:
combining, via a gating model, the first AI model and the second AI model into the ensemble model, wherein the gating model combines the first AI model and the second AI model by combining a first output contribution of the first AI model and a second output contribution of the second AI model into a final determination of the room type, the amenity, the location, or a combination thereof.

3. The system of claim 2, wherein the gating model further combines the first output contribution of the first AI model and the second output contribution of the second AI model into the final determination based on an input test data set.

4. The system of claim 3, wherein the gating model provides as input to the first AI model and to the second AI model the input test data set and to derive a first weight for the first AI model based on a first output of the first AI model and a second weight for the second AI model based on a second output of the second AI model, and wherein the first weight and the second weight are combined to derive the final determination.

5. The system of claim 1, the operations further comprising:
training a third AI model of the plurality of AI models to only derive the room type from the room depicted in the image, to derive both the room type and the amenity found in the room, to derive the location from the image, or a combination thereof, based on a third data set having a different type from the first data set and from the second data set;
combining the first AI model, the second AI model, and the third AI model into the ensemble model; and
providing the ensemble model to classify images.

6. The system of claim 5, the operations further comprising:
combining, via a gating model, the first AI model, the second AI model, and the third AI model into the ensemble model, wherein the gating model derives a final determination of the room type, the amenity, the location, or a combination thereof, based on a vote between the first AI model, the second AI model, and the third AI model.

7. The system of claim 6, wherein the gating model uses a weighted voting between the first AI model, the second AI model, and the third AI model to derive a final determination of the room type, the amenity, the location, or a combination thereof, based on a first weight assigned to the first AI model, a second weight assigned to the second AI model, and a third weight assigned to the third AI model.

8. The system of claim 1, wherein the operations further comprise training the first AI model of the plurality of AI models to only derive the room type and training the second AI model of the plurality of AI models to derive both the room type and the amenity found in the room based on the second data set having a different type from the first data set.

9. The system of claim 1, wherein the first data set comprises a plurality of labeled images and wherein the second data set comprises a plurality of unlabeled images.

10. The system of claim 1, wherein the first data set comprises a first plurality of images divided into X grid divisions and the second data set comprises a second plurality of images divided into Y grid divisions, wherein X is not equal to Y.

11. The system of claim 1, wherein the first data set comprises a first plurality of images having a first image resolution and the second data set comprises a second plurality of images having a second image resolution different from the first image resolution.

12. The system of claim 1, wherein the first AI model comprises a transformer model architecture.

13. The system of claim 12, wherein the transformer model architecture comprises:
a multi-head attention layer comprising a plurality of heads each head focused on different portions of an input image, wherein the input image is converted into a plurality of input embeddings and positional embeddings to be processed via the multi-head attention layer; and
a first add and normalize layer disposed downstream of the multi-head attention layer and configured to mitigate a vanishing gradient problem, wherein an output of the multi-head attention layer is provided as an input to the first add and normalize layer.

14. The system of claim 13, wherein the transformer model architecture further comprises:
a feed-forward layer disposed downstream of the multi-head attention layer and configured to apply a linear transformations to each input position of a feed-forward input; and
a second add and normalize layer disposed downstream of the feed-forward layer and comprising a plurality of second heads each second head focused on different portions of an add and normalize input, wherein the first add and normalize layer provides the feed-forward layer with the feed-forward input and the feed-forward layer provides the second add and normalize layer with the add and normalize input.

15. A non-transitory computer-readable storage medium storing instructions that, when executed by at least one processor, cause the at least one processor to perform operations comprising:
selecting a plurality of Artificial Intelligence (AI) models for training in image classification;
training a first AI model of the plurality of AI models to only derive a room type from a room depicted in an image, to derive both the room type and an amenity found in the room, to derive a location from the image, or a combination thereof, based on a first training data set;
training a second AI model of the plurality of AI models to only derive the room type from the room depicted in the image, to derive both the room type and the amenity found in the room, to derive the location from the image, or a combination thereof, based on a second data set having a different type from the first data set;
combining the first AI model and the second AI model into an ensemble model; and
providing the ensemble model to classify images.

16. The non-transitory computer-readable storage medium of claim 15, wherein the operations further comprise combining, via a gating model, the first AI model and the second AI model into the ensemble model, wherein the gating model combines the first AI model and the second AI model by combining a first output contribution of the first AI model and a second output contribution of the second AI model into a final determination of the room type, the amenity, the location, or a combination thereof.

17. The non-transitory computer-readable storage medium of claim 15, wherein the operations further comprise:
training a third AI model of the plurality of AI models to only derive the room type from the room depicted in the image, to derive both the room type and the amenity found in the room, to derive the location from the image, or a combination thereof, based on a third data set having a different type from the first data set and from the second data set;
combining the first AI model, the second AI model, and the third AI model into the ensemble model; and
providing the ensemble model to classify images.

18. A method, comprising:
selecting a plurality of Artificial Intelligence (AI) models for training in image classification;
training a first AI model of the plurality of AI models to only derive a room type from a room depicted in an image, to derive both the room type and an amenity found in the room, to derive a location from the image, or a combination thereof, based on a first training data set;
training a second AI model of the plurality of AI models to only derive the room type from the room depicted in the image, to derive both the room type and the amenity found in the room, to derive the location from the image, or a combination thereof, based on a second data set having a different type from the first data set;
combining the first AI model and the second AI model into an ensemble model; and
providing the ensemble model to classify images.

19. The method of claim 18, wherein the method further comprises combining, via a gating model, the first AI model and the second AI model into the ensemble model, wherein the gating model combines the first AI model and the second AI model by combining a first output contribution of the first AI model and a second output contribution of the second AI model into a final determination of the room type, the amenity, the location, or a combination thereof.

20. The method of claim 18, wherein the method further comprises:
training a third AI model of the plurality of AI models to only derive the room type from the room depicted in the image, to derive both the room type and the amenity found in the room, to derive the location from the image, or a combination thereof, based on a third data set having a different type from the first data set and from the second data set;
combining the first AI model, the second AI model, and the third AI model into the ensemble model; and
providing the ensemble model to classify images.
